(19) United States
(12) Patent Application Publication
(10) Pub. No.: US 2025/0247267 A1
(43) Pub. Date: Jul. 31, 2025

(54) SYSTEM AND METHOD FOR GRAPH REPRESENTATION FOR HOUSEHOLDS AND APPLICATION THEREOF

(71) Applicant: YAHOO ASSETS LLC, New York, NY (US)

(72) Inventors: Hongjie Chen, Christiansburg, VA (US); Meizhu Liu, Livingston, NJ (US)

(21) Appl. No.: 18/426,690

(22) Filed: Jan. 30, 2024

(51) Int. Cl. H04L 12/28

(52) U.S. Cl. CPC H04L 12/282; H04L 12/2823

(57) ABSTRACT

The present teaching relates to detecting households and content recommendation thereto. Based on information related to user online activities, component graphs are generated to represent corresponding candidate households. The component graphs are classified via a classification model to identify those component graphs representing households. Such component graphs representing households are adapted over time according to the dynamics of the user online activities.

### BACKGROUND

### 1. Technical Field

The present teaching generally relates to information processing. More specifically, the present teaching relates to processing data related to online users.

### 2. Technical Background

With the development of the Internet and the ubiquitous network connections, more and more commercial and social activities are conducted online. Networked content, some requested and some recommended, is served to millions of households. Such online content includes publications, articles, communications, as well as advertisements. Online platforms make electronic content available to different users or different households to maximally monetize the platforms by estimating the preferences of individual users and households. For example, interests of different users may be estimated so that content that meet each user's interests may be provided to the user. Efforts have been made to achieve such individualization at the user level by analyzing user online activities directed at content related to different interests.

While such personalization may be performed with respect to individual users, it is also beneficial to apply to different groups of users who may share some common interests. Examples may include households and online special interest groups or chatrooms. While online special interest groups or chatrooms may be structured in such a way that users in each of such groups may be readily identified via their memberships or identifications associated with their corresponding groups. On the other hand, a household, although individualization is meaningful, may be quite different. First, members of a household usually may not share the same interests, act in similar ways, or be active in the same online settings. For instance, a household may include parents and children and they may have shared and diverse interests. Different members may use separate devices and be active in different online settings. In the meantime, they may also consume the same content on the same online devices, e.g., they may watch the same programs/movies in the evenings or on weekends. In addition, the household interests may change with time, due to, e.g., changed interests of some member(s) and/or a change of the members (e.g., children left home for school, relative visits, etc.). Given that, challenges exist in identifying households so that household interests may be detected and then accordingly used to serve the households appropriately.

Thus, there is a need for developing an approach to solve the issues associated therewith.

### SUMMARY

The teachings disclosed herein relate to methods, systems, and programming for information management. More particularly, the present teaching relates to methods, systems, and programming related to content processing and categorization.

In one example, a method, implemented on a machine having at least one processor, storage, and a communication platform capable of connecting to a network for detecting households and content recommendation thereto. Based on information related to user online activities, component graphs are generated to represent corresponding candidate households. The component graphs are classified via a classification model to identify those component graphs representing households. Such component graphs representing households are adapted over time according to the dynamics of the user online activities.

In a different example, a system is disclosed for displaying ads that includes a user activity determiner, a component graph generator, a household-graph (H-graph) representation classifier, and an H-graph representation maintenance unit. The user activity determiner is provided for receiving information related to user online activities. The component graph generator is provided for generating a plurality of component graphs representing candidate households based on the information related to user online activities. The H-graph representation classifier is provided for classifying the plurality of component graphs to identify component graphs corresponding to households. The H-graph representation maintenance unit is provided for adapting the component graphs corresponding to households based on dynamics of the user online activities.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for detecting households and content recommendation thereto. When the information recorded on the medium is read by the machine, it causes the machine to perform various steps. Based on information related to user online activities, component graphs are generated to represent corresponding candidate households. The component graphs are classified via a classification model to identify those component graphs representing households. Such component graphs representing households are adapted over time according to the dynamics of the user online activities.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary framework for creating graph-based household representations for households and maintenance thereof, in accordance with an embodiment of the present teaching;

FIG. 1B is a flowchart of an exemplary process of an exemplary framework for creating graph-based household representations for households and maintenance thereof, in accordance with an embodiment of the present teaching;

FIG. 2A shows exemplary types of entity identifiers, in accordance with an embodiment of the present teaching;

FIG. 2B illustrates exemplary types of connections considered in constructing a graph representation for a household, in accordance with an embodiment of the present teaching;

FIG. 3A depicts an exemplary high level system diagram of a component graph generator, in accordance with an embodiment of the present teaching;

FIG. 3B illustrates exemplary types of connection filtering rules, in accordance with an embodiment of the present teaching;

FIG. 3C illustrates exemplary types of component filtering rules, in accordance with an embodiment of the present teaching;

FIG. 3D is a flowchart of an exemplary process of a component graph generator, in accordance with an embodiment of the present teaching;

FIG. 4A depicts an exemplary high-level system diagram of a household graph representation classifier, in accordance with an embodiment of the present teaching;

FIG. 4B shows an exemplary implementation of a household graph representation classifier based on a multi-layer neural network with different sub-networks, in accordance with an embodiment of the present teaching;

FIG. 4C is a flowchart of an exemplary process of household graph representation classifier, in accordance with an embodiment of the present teaching;

FIG. 5A depicts an exemplary high level system diagram of a framework for providing personalized online services to households, in accordance with an embodiment of the present teaching;

FIG. 5B is a flowchart of an exemplary process for detecting household interests based on online activities of members of households represented by graph representations obtained in accordance with an embodiment of the present teaching;

FIG. 5C is a flowchart of an exemplary process for providing personalized online services to households based on their respective interests, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses a framework for generating graph representations for households and use thereof in personalized online services. Graphs representing entity connections may be obtained and component graphs may be extracted based on the characteristics of the entity connections. Component graphs may then be automatically classified via machine trained models to recognize graphs that correspond to households. The recognized graphs representing households may then be adaptively updated over time based on dynamically detected changes in entity connections. Such dynamically maintained household graphs may be utilized to detect interests/preferences associated with members of each household so that online services may be personalized with respect to the household.

To obtain graph-based household representations, different types of entity connections may be collected and filtered based on heuristic rules so that noisy and irrelevant entity connections that are inconsistent with the nature of household related user activities may be excluded from household representations. An overall graph is constructed using the filtered entity connections associated with all entities, including users, devices, browsers, etc. Component graphs embedded in the overall graph may be identified as sub-graphs in accordance with certain conditions. Such sub-graphs or component graphs may be further filtered based on heuristics so that component graphs that likely are not associated with households may be removed. The remaining component graphs may be used as representations for household candidates.

The component graphs representing household candidates may be, according to the present teaching, classified by a classifier trained via machine learning to recognize component graphs that correspond to households. In some embodiments, each component graph may be processed to obtain embeddings corresponding to a feature vector representing the component graph used for classification as to whether the component graph represents a household. In some embodiments, embeddings for each component graph may be achieved in multiple steps. Embeddings for each node of the component graph may be obtained based on the features associated with the node as well as each of the connections from the node to any other node in the component graph. The embeddings for the nodes of the component graph may then be aggregated to obtain the integrated embeddings for the entire component graph or the feature vector of the component graph. As discussed herein, the component graphs that are classified as representing households are then used to determine corresponding interests of different households. In some embodiments, online activities of members of each household may be analyzed to detect interests associated with the household so that content/services may be recommended to the household based on such detected household interests.

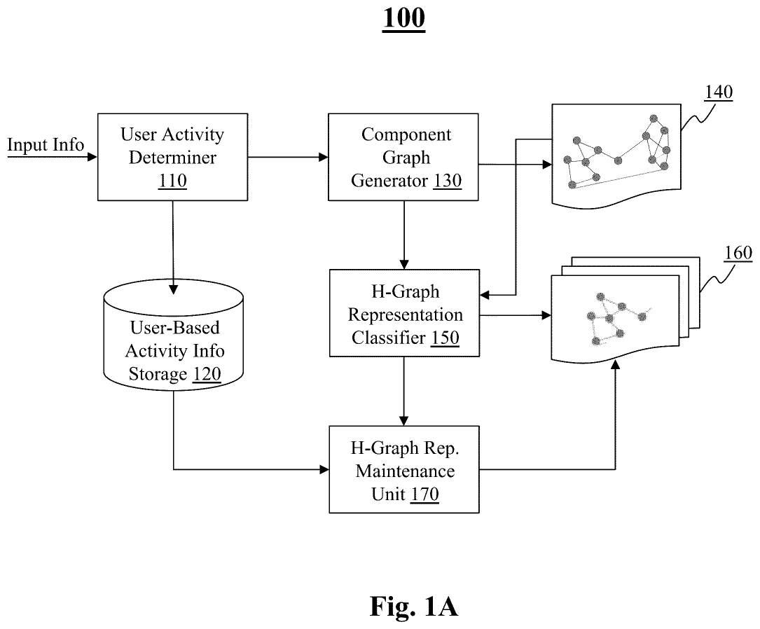

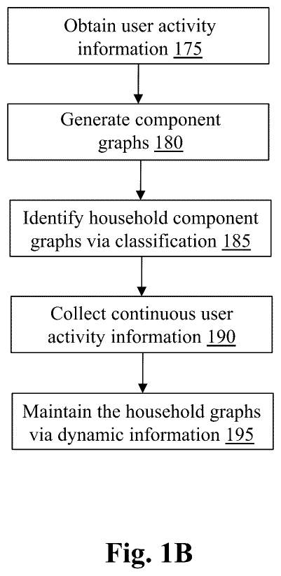

FIG. 1A depicts an exemplary framework 100 for creating graph-based household representations for households and the maintenance thereof, in accordance with an embodiment of the present teaching. In this illustrated framework 100, the input includes information collected about online activities of users, whether conducted on any devices that may be connected to the Internet, including computers, tablets, smart phones, personal data assistant devices, wrist watches, or any wearable devices. The output of the framework 100 includes a plurality of households detected based on the input user activities and represented by corresponding graph representations 160. To produce the intended output based on the given input, the framework 100 comprises a user activity determiner 110, a component graph generator 130, a household graph (H-graph) representation classifier 150, and a H-graph representation maintenance unit 170.

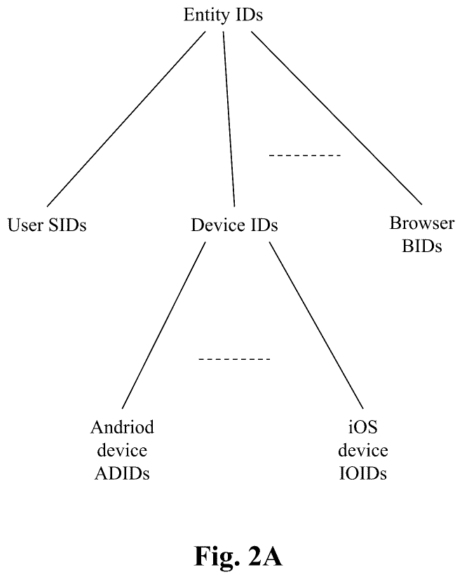

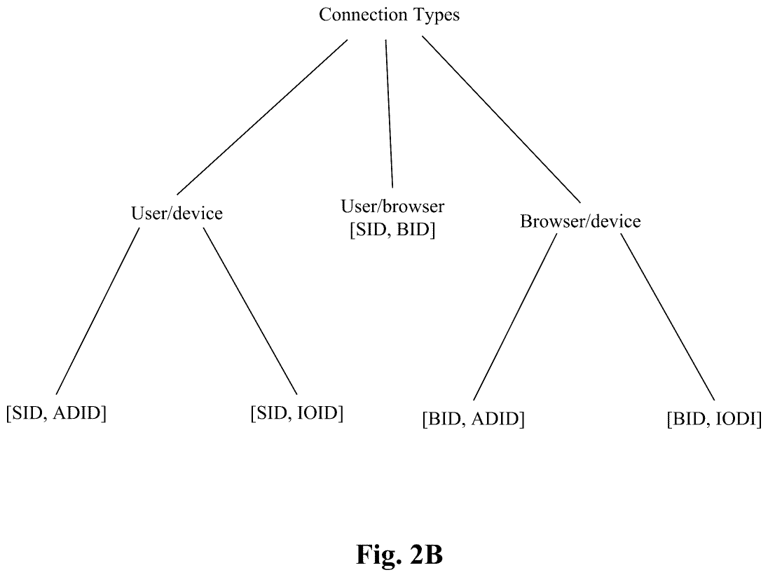

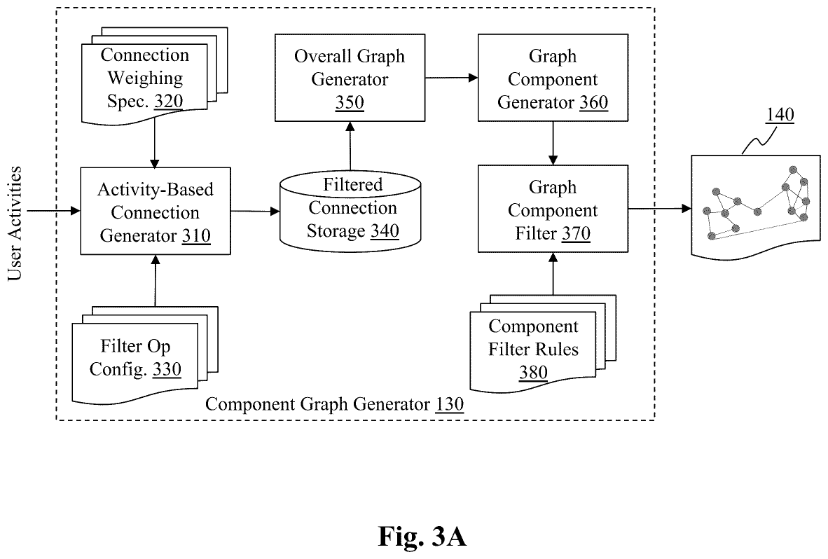

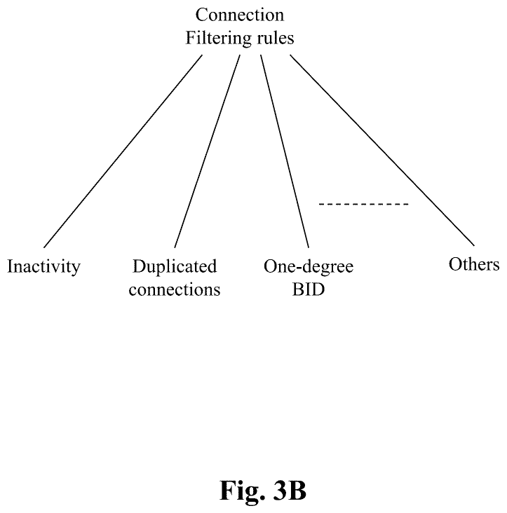

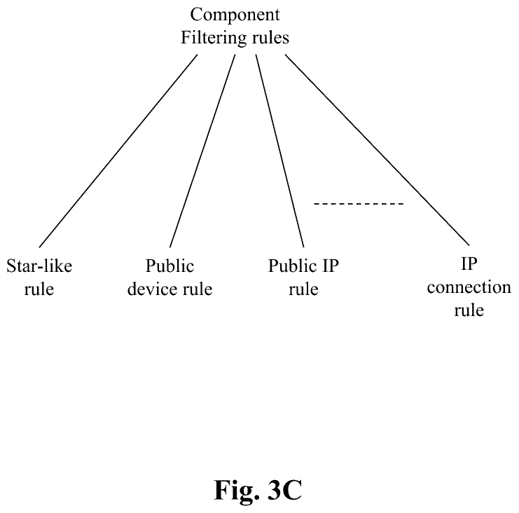

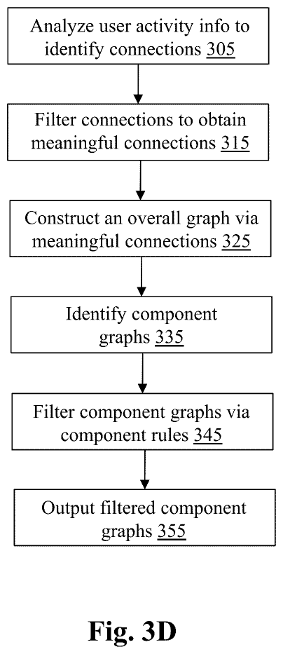

In this illustrated embodiment, the user activity determiner 110 may be provided to analyze the input user online activities, identify activities associated with each individual user, and save the such user-centric activity information in a user-based activity information storage 120. In some embodiments, the online user activity information may be continuously collected, analyzed with respect to individual users, and stored in 120. Based on the analysis on the input user activity information, the component graph generator 130 may be provided to create component graphs 140 based on an overall graph constructed based on the connectivity information extracted from the input user online activity information. Details related to how to establish an overall graph and then extract component graphs therefrom are provided with reference to FIGS. 2A-3D.

According to the present teaching, the overall graph constructed based on connectivity of entities may represent all connections among entities, which may include users, devices, browsers, etc. In this overall graph, a node may represent an entity and an edge between two nodes (corresponding to two entities) may represent a connection. For example, a user (an entity) may use a smart phone (a device corresponding to another entity) to connect to Yahoo.com (a website which corresponds to another entity). A component graph may be a part of the overall graph, extracted therefrom based on certain criteria. For instance, a component graph in 140 may correspond to a sub-graph of the overall graph that meets certain conditions, e.g., the nodes having mostly connections among nodes of the component graph and with minimum connections to other nodes outside of the component graph. Such a component graph may represent a candidate household that may be further classified as to whether the users corresponding to certain nodes of the component graph belong to the same household.

The H-graph representation classifier 150 may be provided to classify each of the component graphs in 140 as to whether it corresponds to a household. The component graphs that are classified as representing households, they are stored in 160. Such graph household representations may be updated regularly over time. In some situations, households may be detected regularly via updated user activity information via, e.g., the user activity determiner 110, the component graph generator 130, and the H-graph representation classifier 150 as discussed herein to accommodate the changes where new households may be formed, previous households may disappear, and some households may change in size, etc. In a different approach, the detected households and their graph representations in 160 may be adaptively maintained whenever there is new user activity information is input and updated in the user-based activity information storage 120. This may be achieved by the H-graph representation maintenance unit 170. In some embodiments, based on the updated user-based activity information stored in 120, the H-graph representation maintenance unit 170 may modify the information in the graph representation of related households so that the component graphs stored in 160 to represent active households are up to date and characterize the households.

Once the graph representations for households are obtained, they may be utilized as the basis for personalizing services to each household. For instance, the interests of members of each household may be identified based on its graph representation and the online user activity information and may be leveraged to individualize services/contents to be delivered to the household. Such individualization may be carried out in addition to the personalization with respect to each user of the household, further enhancing the services and user experiences.

FIG. 1B is a flowchart of an exemplary process of the framework 100 for creating graph-based household representations for households and maintenance thereof, in accordance with an embodiment of the present teaching. As discussed herein, in operation, when the user activity determiner 110 receives input online information, it analyzes the input and obtains, at 175, user activity information and stores the same in the user-based activity information storage 120, based on which, the component graph generator 130 generates, at 180, component graphs 140. Such derived component graphs are then processed by the H-graph representation classifier 150 to identify, at 185, component graphs that represent household graph representations 160. To maintain the relevance of the household graph representations, the user activity determiner 110 continues to collect and derive, at 190, updated user-based activity information in 120, which is then utilized by the H-graph representation maintenance unit 170 to maintain, at 195, the household graph representations 160 according to the dynamic information related to the users.

As discussed herein, the households may be identified based on online connections among entities, which include, e.g., users, devices, browsers, etc. The connections among such entities may be identified via their respective identifiers. For example, a user with a certain unique identifier may use a device with a unique device identifier to connect to a particular online source such as a browser which may be identified via a unique identifier. FIG. 2A shows exemplary types of entity identifiers, in accordance with an embodiment of the present teaching. As illustrated, entities considered in household detection may include users, devices, online sources such as browsers, etc. Such entities may be represented by corresponding identifiers that may be unique across the network so that connections among different entities may be identified. As illustrated, entities may be represented by their unique identifiers. That is, each user may be associated with a unique identifier. A device may include a computer, a tablet, a smart phone, a wireless phone, a personal data assistant, a wearable device such as wristwatch or any device that may be carried around and used to make network connections. Such devices may be operating under different operating systems (OS) which may be identifiable based on both device identifier (ID) and the OS. For instance, a device may be running under an Android operating system (AD) with an identifier (ID), an iOS operating system identifiable using an identifier, e.g., IOID. These are provided merely for illustration instead of limitation. Any other entities and identifiers may be included so long as the entities may be connected with each other via network connections using their respective identifiers.

Entities may be connected in different ways, and they are relevant to the present teaching in terms of how to identify households. FIG. 2B illustrates exemplary types of connections considered in constructing a graph representation for a household, in accordance with an embodiment of the present teaching. In this illustration, a user (an entity) may connect to a device (also an entity) so that the connection is of user/device type. A user may also connect to an Internet source such as a browser (also an entity) via a, e.g., user/browser connection. A device may be used to make a connection to an Internet source such as a browser via a, e.g., a device/browser connection. Each of such connections may involve a pair of entities, each of which may be identified using their respective identifications. As such, each connection may be identified using a pair of identifiers. As shown, a user/device connection may be identified using a pair of identifiers [SID, DID], wherein SID denotes a user IS and DID denotes a device ID. As discussed herein, each device may be further identified based on the operating system it is using so that a device running on an Android system may be identified by an ADID and a device running on an iOS operating system may be identified as IOID. Given that, a user/device connection may be identified by either [SID, ADID] or [SID, IOID].

Another type of illustrated connection is between a user and an Internet source such as a browser and this type of connection may be denoted using a pair of ID such as [SID, BID], where BID represents an identifier of an Internet source such as a browser. Similarly, a connection between a device and an Internet source such as a browser may be accordingly represented by a pair of IDs, such as [BID, ADID] for a connection between an Android device and an Internet source identified by identifier BID and [BID, IOID] for a connection between an iOS device and an Internet source with an identifier BID. Other connections may also be possible and may be similarly identified via the identifiers of the connected entities. Each of such pairs of IDs represents a connection and may be used as the basis to detect households. In some embodiments, additional information associated with any of the entities may also be obtained and used in detecting households. For instance, an IP address associated with an Internet service provided to a household may be used by different members of the household to access (e.g., via different devices) content from different Internet sources (e.g., Yahoo, Google, Facebook, Amazon, etc.).

FIG. 3A depicts an exemplary high level system diagram of the component graph generator 130, in accordance with an embodiment of the present teaching. As discussed herein, the component graph generator 130 is provided for identifying component graphs from an overall graph constructed based on user activity information (e.g., connections among different entities) as candidate households. In this illustrated embodiment, the component graph generator 130 comprises an activity-based connection generator 310, an overall graph generator 350, a graph component generator 360, and a graph component filter 370. As user activity information is received, entity connections may be identified from such information and provided to the activity-based connection generator 310 for extracting connections that are relevant for the purpose of detecting households, as some entity connections existing in the user activity information may be relevant to household detection and some may not. Given that, connections extracted from input user activity information may need to be filtered to obtain relevant connections for household determination.

FIG. 3B illustrates some exemplary types of rules for filtering connections, in accordance with an embodiment of the present teaching. For example, some of the connections, although included in the user activity data, may no longer be active or inactive within a defined period. In some situations, the user activity information may include duplicated connections. For instance, if entity 1 made a connection with entity 2, the connection may be recorded by both entity 1 and entity 2 even though they correspond to the same connection. As user activity information may include millions of connections, in some embodiments, connections may be reduced by filtering out Internet sources such as a browser that is accessed via indirect linkages by, e.g., either retaining first-degree sources or by aggregating multiple Internet sources accessed via the vertical searches, i.e., linking multiple BIDs to the same SID of the user and/or device ID. The filtering rules may also include other types of criteria and may be employed based on the needs of an application in hand. Through such filtering, connections that may not contribute to relevant information for identifying households may be filtered out.

The remaining relevant connections may be stored in a filtered connection storage 340, where each connection may include two connected nodes representing entities. The filtered connections may then be used by the overall graph generator 350 to construct an overall graph representing meaningful connections extracted from the input user activity information. The overall graph constructed in this way may include hundreds of millions of SID nodes along with many millions of other nodes representing, e.g., BIDs or device IDs, and may then be used by the graph component generator 360 to extract component graphs, each of which may be defined as a maximal subgraph where all nodes therein may reach each other through some connections and have no access to any node outside of it, i.e., a maximal component graph is incapable of reaching an external node. The component graphs extracted from the overall graph may be used to identify useful information. For example, based on each component graph, information related to users involved as well as their associated targetable entities may be identified. In addition, connections between different users within a component graph may also be identified.

In general, the component graphs extracted by the graph component generator 360 from the overall graph may need to be filtered to, e.g., remove those nodes or connections that represent users pr activities that do not correspond to households or private household activities. For instance, a component graph for a household may be of a reasonable size (e.g., worth of targeting) and may not include devices that correspond to public devices. In addition, connections in the component graph may not include those associated with public IP addresses. Furthermore, a component graph for a household is to exhibit strong relationships among user IDs or SID nodes (i.e., family ties). The graph component filter 370 may be provided to filter the component graphs based on some predetermined component filter rules stored in 380.

FIG. 3C illustrates exemplary types of component filtering rules, in accordance with an embodiment of the present teaching. As shown, component filtering rules may include some public device rule provided for filtering out devices included in component graphs that are public devices. For instance, the public device rule may be set so that any device that is connected to more than X SIDs may be deemed as a public device and may be removed. Filtering rules may also include a public IP rule provided for filtering out public IP. For instance, if an IP meets certain conditions, it may be deemed as a public IP, e.g., the number of SIDs>X1 and the number of device IDs>X2, where X1 and X2 are thresholds provided based on application needs. With respect to such identified public IPs, connections in component graphs to such identified public IPs may also be removed. In some situations, component graphs that share IPs may be merged because such component graphs may correspond to the same household. Such rules may be applied in combination or individually, according to the needs of specific applications.

In some embodiments, rules may also be provided to identify component graphs as corresponding to households if they exhibit strong user connections, determined according to some criteria to measure, e.g., the family ties. For example, if the number of users (i.e., number of SIDs) involved in a component graph is A and the number of non-user entities (e.g., devices or browsers) involved in the same component graph is B, a rule may be defined based on A and B to measure the strength of family ties. One example definition may be that the degree of ties among SIDs and other entities exceeds c*A*B, where c is a constant provided to represent the desired degree of family ties. As shown in FIG. 3A, different component filtering rules may be specified in 380 and the graph component filter 370 may access the filtering rules as configured in 380 to process the component graphs. Some nodes and connections in component graphs may be filtered out (e.g., if they meet the criteria of public devices rule, public IP rule, or IP connections rules). Some component graphs may be found to exhibit strong connections.

In some embodiments, in processing the component graphs, the graph component filter 370 may also derive relevant features associated with nodes or edges of each component graph. For instance, for each SID (a user) in a component graph, the associated targetable entities (such as devices or browsers) may be identified and used to compute a feature for the SID node. Connections among entity IDs in a component graph may also be detected. These detected features may be used to add attributes to either nodes in the component graph (e.g., if a user SID has more connections with other targetable entities, the node may be given a higher weight) or connections (e.g., if more SIDs share the same connection, the edge corresponding to the connection may be given a higher weight) of the component graph. Such filtered component graphs may represent candidate households and be stored in 140 to be further processed to determine which component graphs correspond to households.

FIG. 3D is a flowchart of an exemplary process of the component graph generator, in accordance with an embodiment of the present teaching. Based on the input user activity information, the activity-based connection generator 310 may analyze, at 305, the input information to identify connections among entities. As discussed herein, the activity-based connection generator 310 may also filter, at 315, the connections among entities extracted from the user activity information according to, e.g., the configuration in 330 specifying the filtering operation. As discussed herein with respect to FIG. 3B, connections that are inactive, duplicated, etc. may be removed. The resultant filtered connections may be stored in the filtered connection storage 340 and are accessed by the overall graph generator 350 to construct, at 325, an overall graph. Based on the overall graph, the graph component generator 360 identifies, at 335, various component graphs embedded in the overall graph, which are then filtered, at 345, by the graph component filter 370 based on filtering rules specified in 380, as discussed herein. The filtered component graphs are output, at 355, as the component graphs 140 representing the household candidates to be further processed.

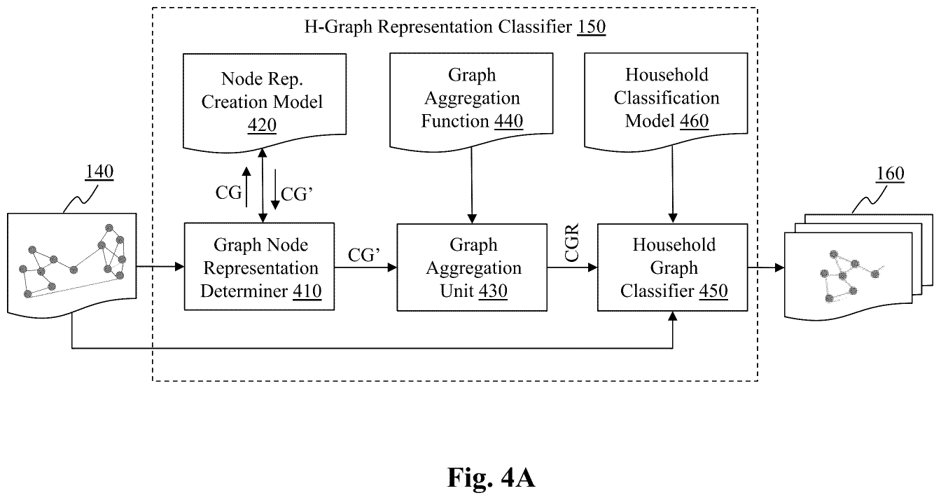

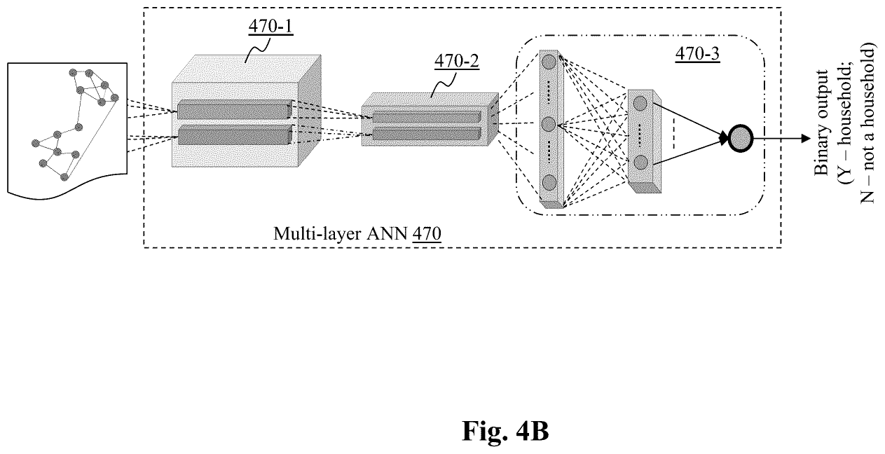

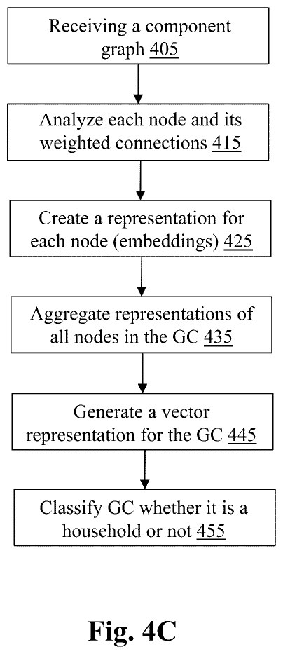

As discussed herein with respect to FIG. 1A, once the component graph generator 130 produces the component graphs 140 representing household candidates, the H-graph representation classifier 150 processes the component graphs in 140 and classifies each as whether it represents a household or not to obtain components graphs in 160 corresponding to households. FIG. 4A depicts an exemplary high-level system diagram of the household graph representation classifier 150, in accordance with an embodiment of the present teaching. In this illustrated embodiment, the H-graph representation classifier 150 represents a graph classification (GC) model that operates by taking a component graph as input and producing a binary label indicating whether the input component graph represents a household or not. If the input component graph is classified as a household graph, then the SIDs in the component graph are identified as being in the same household and the corresponding users are deemed as household members.

In the embodiment illustrated in FIG. 4A, the H-graph representation classifier 150 comprises a graph node representation determiner 410, a graph aggregation unit 430, and a household graph classifier 450. The classification for each component graph may be carried out in three stages. The first stage may be performed by the graph node representation determiner 410 to obtain a representation for each node in the input component graph. It may take a component graph (CG) as input and then generate a modified CG′ with each node associated with a node representation. In some embodiments, a node representation may correspond to embeddings produced, via, e.g., a node representation creation model 422. The node representation creation model 420 may be trained, via machine learning, to obtain, for each node, embeddings based on, e.g., features associated with the node, connections between the node and other entities in the input component graph, as well as features associated with such connections. Embeddings obtained for each node may be considered as a feature vector associated with the node.

Based on node representations (e.g., node embeddings), the graph aggregation unit 430 may be provided to, in the second stage, aggregate node representations for node in the input component graph to create an aggregated representation for the component graph. In some embodiments, the aggregation may be defined by some pre-determined graph aggregation function 440. For example, when node representations correspond to embeddings, the graph aggregation function 440 may specify to derive embeddings for the input component graph by integrating the node embeddings via defined computation(s) to derive embeddings for the component graph. In some embodiments, the representation for the component graph (or CGR) may correspond to a feature vector (embeddings) and used by the household graph classifier 450 as an input for classification to produce a binary decision on whether the input component graph represents a household or not. As illustrated, the classification may be performed in accordance with a household classification model 460, which may be previously trained for recognizing household graphs based on a feature vector representing a corresponding component graph. If an input component graph is classified as a household, the component graph may be stored as a household representation in the household graph storage 160.

In some embodiments, the multi-staged H-graph representation classifier 150 may be implemented using a multi-layer neural network with different sub-networks, each of which may perform tasks of a particular stage. The sub-networks of the multi-layer neural network may be trained simultaneously to optimize the overall performance. FIG. 4B shows an exemplary implementation of the household graph representation classifier 150 using a multi-layer artificial neural network (ANN) 470 with different sub-networks, in accordance with an embodiment of the present teaching. As illustrated, the multi-layer ANN 470 takes an input component graph as input and produces a binary output indicative of whether the input component graph represents a household or not. In this illustrated implementation, the multi-layer ANN 470 includes a first sub-network 470-1, a second sub-network 470-2, and a third sub-network 470-3.

The first sub-network 470-1 may be trained for generating, for each node of an input component graph (CG), embeddings via, e.g., a graph neural network based on, e.g., the node's representation (e.g., features) and the node representations of its neighboring nodes connected therewith. In some embodiments, the features associated with the connections to the neighboring nodes may also be considered. The first sub-network 470-1 outputs, for each node, a new node representation with a vector-based representation (embeddings). The second sub-network 470-2 may be trained to aggregate the new node representations for nodes via an aggregation function and output a graph representation in the form of a vector obtained via aggregation.

The third sub-network 470-3 may be provided for classification, which may be trained to generate, based on the input graph representation (or feature vector) for the component graph, a binary label, where a positive label indicates that the input CG is a household and a negative label indicates that the input CG is not a household. This multi-layer graph neural network with different sub-networks may be trained, via, e.g., supervised machine learning, to learn to carry out tasks at different stages to achieve expected overall classification performance. It is noted that this exemplary ANN architecture provided herein is merely for illustration, instead of as a limitation, and other implementations may also be possible, and they are within the scope of the present teaching. t

FIG. 4C is a flowchart of an exemplary process of the household graph representation classifier 150, in accordance with an embodiment of the present teaching. As discussed herein, in operation, when an input component graph is received at 405, features associated with each node as well as its (weighted) connections to other entity nodes are analyzed at 415 and used to create, at 425, a vector representation (such as embeddings) therefor. The vector representations for all nodes included in the component graph may then aggregated, at 435, to generate, at 445, a feature vector (such as embeddings) representation for the component graph, which is then used as input to classify, at 455, whether it represents a household or not. The component graphs that are classified as representing households may then be archived in 160 as active households and may be used for, e.g., personalized services to different households. As discussed herein, because online user activities may change over time, the detected households and the representations thereof may be adapted to the online dynamics according to continuously collected user activity information.

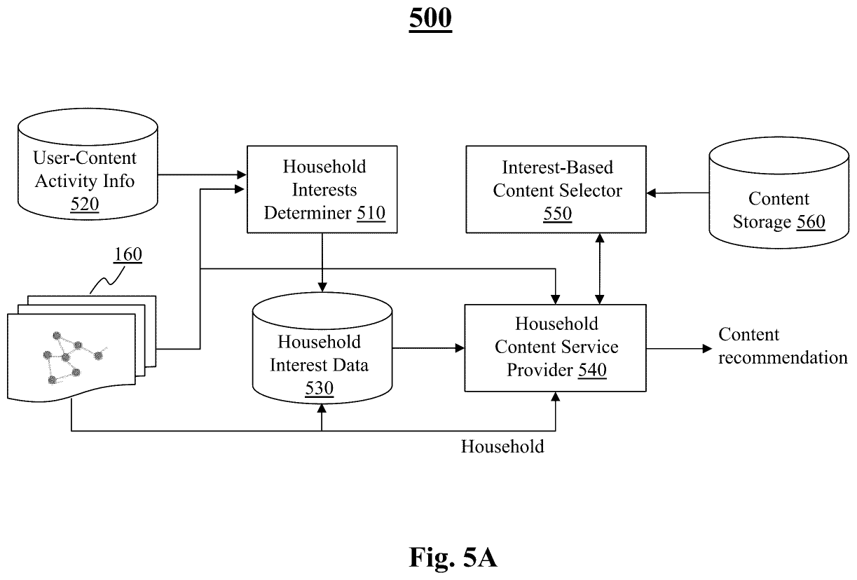

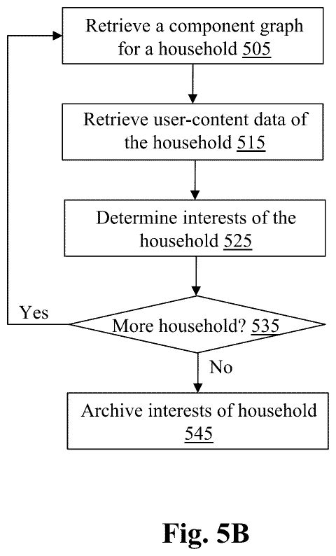

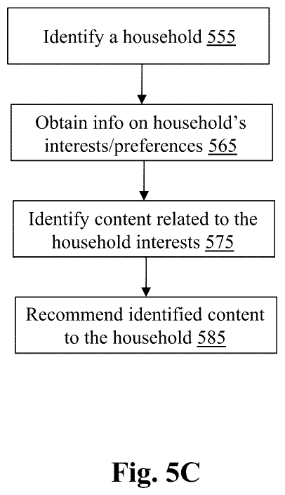

As discussed herein, the households detected and represented according to the present teaching may be used in applications such as personalizing online services with respect to households or individuals in different households. FIG. 5A depicts an exemplary high level system diagram of an application 500 for providing personalized content recommendation services to households, in accordance with an embodiment of the present teaching. The application 500 includes two parts, one for identifying interests/preferences associated with different households and the other for recommending content to households in a personalized manner based on the household interests/preferences. The first part includes a household determiner 510 that takes user-content activity information 520 and representations of households 160 detected according to the present teaching. The second part includes a household content service provider 540 and an interest-based content selector 550. The household content service provider 540 may be provided to recommend content to households selected, by the interest-based content selector 550, according to the interests/preferences associated with the households.

FIG. 5B is a flowchart of an exemplary process for detecting household interests based on online activities of members of households represented by graph representations obtained in accordance with an embodiment of the present teaching. As discussed herein, households detected according to the present teaching may be represented by component graphs. To determine the interests/preferences of members of each household, its corresponding component graph representing the household may be retrieved from 160 at 505. Based on the component graph with nodes and connections, the household interest determiner 510 retrieves, at 515, user-content activity information from 520 associated with members of the household to determine, at 525, the interests/preferences of the household. For example, the user-content activity information may reveal the content the member(s) of the household consumed in the past and the interests exhibited by member(s) of the household with respect to different pieces of content. Through such user-content activity information, topics of interests/preferences may be identified to represent the interests/preferences of the household and may be stored in a household interest data storage 530. The operation may continue until, determined at 535, the interests/preferences are identified for all the households and archived in 530 at 545.

Once the household interests/preferences are identified, the second part of the application 500 operates to provide household personalized services by recommending content to different households according to their respective interests/preferences. FIG. 5C is a flowchart of an exemplary process for the second part of application 500 for providing personalized content services to households based on their respective interests, in accordance with an embodiment of the present teaching. In operation, when the household content service provider 540 identifies, at 555, a household for content service, information about the interests/preferences of the household is obtained, at 565, from the household interest data storage 530. The interests/preferences information relevant to the household is provided to the interest-based content selector 550, which obtains, at 575, content for the household that is consistent with the estimated interests/preferences of the household. With the personalized content selected for the household, the household content service provider 540 recommends, at 585, the personalized content to the household. Although the application 500 is provided as an exemplary use of household representation obtained according to the present teaching, such detected household information may be used in many other applications for different purposes.

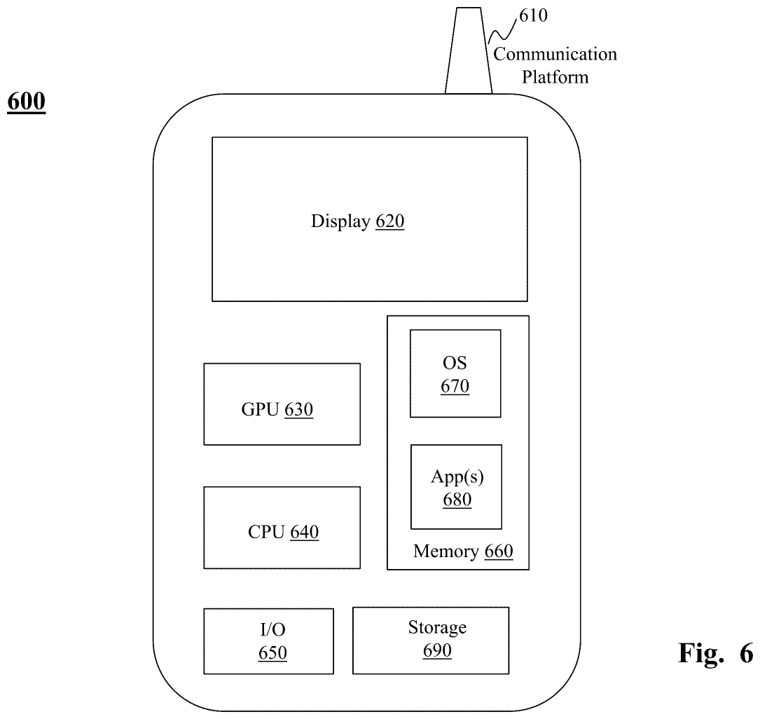

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 500, including, but not limited to, a smart phone, a tablet, a music player, a handled gaming console, a global positioning system (GPS) receiver, and a wearable computing device, or in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 500. As shown in FIG. 6, a mobile operating system 670 (e.g., iOS, Android, Windows Phone, etc.), and one or more applications 680 may be loaded into memory 660 from storage 690 in order to be executed by the CPU 640. The applications 680 may include a user interface or any other suitable mobile apps for information analytics and management according to the present teaching on, at least partially, the mobile device 600. User interactions, if any, may be achieved via the I/O devices 650 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

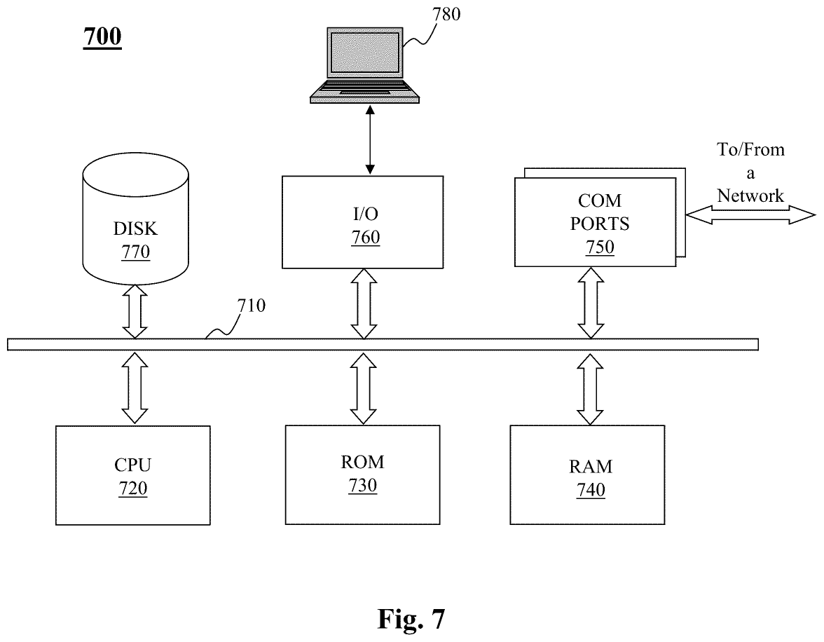

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information analytical and management method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware or a combination, hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, comprising:
receiving information related to user online activities;
generating a plurality of component graphs representing candidate households based on the information related to user online activities;
classifying the plurality of component graphs to identify component graphs corresponding to households;
adapting the component graphs corresponding to households based on dynamics of the user online activities.

2. The method of claim 1, wherein the user online activities include connections among entities, wherein the entities include
users;
devices capable of connecting to the Internet; and
online information sources including browsers.

3. The method of claim 2, wherein the step of generating a plurality of component graphs comprises:
identifying relevant connections among entities based on the information related to online user activities;
constructing an overall graph based on the connections, wherein the overall graph includes nodes corresponding entities and edges corresponding to connections among entities represented by the nodes;
extracting, from the overall graph, the plurality of component graphs based on a predetermined condition, wherein
each of the plurality of component graphs includes edges representing connections of different entities represented by nodes included in the component graph and none of the nodes in the component graph is connected to a node outside of the component graph.

4. The method of claim 3, wherein the step of identifying relevant connections among entities comprises:
extracting, from the information related to online user activities, connections between two entities;
removing some of the connections based on one or more predetermined filtering criteria;
providing remaining connections as the relevant connections.

5. The method of claim 1, wherein the step of classifying the plurality of component graphs comprises:
with respect to each of the plurality of component graphs,
obtaining a node representation for each of nodes included in the component graph,
aggregating node representations of the nodes included in the component graph to derive a representation for the component graph,
classifying, based on a household classification model previously trained via machine learning, the component graph based on the representation of the component graph with a binary label indicative of whether the component graph characterizes a household.

6. The method of claim 1, further comprising:
analyzing user-content activity information related to members of a household represented by a component graph, wherein the user-content activity information related to the members records content consumed by the members and activities of the members with respect to the content;
estimating one or more interests of the household based on the user-content activity information.

7. The method of claim 6, further comprising providing personalized content service by:
identifying a service household for personalized content service;
obtaining one or more interests estimated with respect to the service household;
identifying content in alignment with the one or more interests associated with the service household; and
recommending the identified content to the service household.

8. A machine readable and non-transitory medium having information recorded thereon, wherein the information, when read by the machine, causes the machine to perform the following steps:
receiving information related to user online activities;
generating a plurality of component graphs representing candidate households based on the information related to user online activities;
classifying the plurality of component graphs to identify component graphs corresponding to households;
adapting the component graphs corresponding to households based on dynamics of the user online activities.

9. The medium of claim 8, wherein the user online activities include connections among entities, wherein the entities include
users;
devices capable of connecting to the Internet; and
online information sources including browsers.

10. The medium of claim 9, wherein the step of generating a plurality of component graphs comprises:
identifying relevant connections among entities based on the information related to online user activities;
constructing an overall graph based on the connections, wherein the overall graph includes nodes corresponding entities and edges corresponding to connections among entities represented by the nodes;
extracting, from the overall graph, the plurality of component graphs based on a predetermined condition, wherein
each of the plurality of component graphs includes edges representing connections of different entities represented by nodes included in the component graph and none of the nodes in the component graph is connected to a node outside of the component graph.

11. The medium of claim 10, wherein the step of identifying relevant connections among entities comprises:
extracting, from the information related to online user activities, connections between two entities;
removing some of the connections based on one or more predetermined filtering criteria;
providing remaining connections as the relevant connections.

12. The medium of claim 8, wherein the step of classifying the plurality of component graphs comprises:
with respect to each of the plurality of component graphs,
obtaining a node representation for each of nodes included in the component graph,
aggregating node representations of the nodes included in the component graph to derive a representation for the component graph,
classifying, based on a household classification model previously trained via machine learning, the component graph based on the representation of the component graph with a binary label indicative of whether the component graph characterizes a household.

13. The medium of claim 8, wherein the information, when read by the machine, further causes the machine to perform the following steps:
analyzing user-content activity information related to members of a household represented by a component graph, wherein the user-content activity information related to the members records content consumed by the members and activities of the members with respect to the content;
estimating one or more interests of the household based on the user-content activity information.

14. The medium of claim 13, wherein the information, when read by the machine, further causes the machine to perform the step of providing personalized content service via:
identifying a service household for personalized content service;
obtaining one or more interests estimated with respect to the service household;
identifying content in alignment with the one or more interests associated with the service household; and
recommending the identified content to the service household.

15. A system, comprising:
a user activity determiner implemented by a processor and configured for receiving information related to user online activities;
a component graph generator implemented by a processor and configured for generating a plurality of component graphs representing candidate households based on the information related to user online activities;
a household-graph (H-graph) representation classifier implemented by a processor and configured for classifying the plurality of component graphs to identify component graphs corresponding to households;
an H-graph representation maintenance unit implemented by a processor and configured for adapting the component graphs corresponding to households based on dynamics of the user online activities.

16. The system of claim 15, wherein the user online activities include connections among entities, wherein the entities include
users;
devices capable of connecting to the Internet; and
online information sources including browsers.

17. The system of claim 16, wherein the step of generating a plurality of component graphs comprises:
identifying relevant connections among entities based on the information related to online user activities;
constructing an overall graph based on the connections, wherein the overall graph includes nodes corresponding entities and edges corresponding to connections among entities represented by the nodes;
extracting, from the overall graph, the plurality of component graphs based on a predetermined condition, wherein
each of the plurality of component graphs includes edges representing connections of different entities represented by nodes included in the component graph and none of the nodes in the component graph is connected to a node outside of the component graph.

18. The system of claim 17, wherein the step of identifying relevant connections among entities comprises:
extracting, from the information related to online user activities, connections between two entities;
removing some of the connections based on one or more predetermined filtering criteria;
providing remaining connections as the relevant connections.

19. The system of claim 15, wherein the step of classifying the plurality of component graphs comprises:
with respect to each of the plurality of component graphs,
obtaining a node representation for each of nodes included in the component graph,
aggregating node representations of the nodes included in the component graph to derive a representation for the component graph,
classifying, based on a household classification model previously trained via machine learning, the component graph based on the representation of the component graph with a binary label indicative of whether the component graph characterizes a household.

20. The system of claim 15, further comprising:
a household interest determiner implemented by a processor and configured for recommending content to a household by:
analyzing user-content activity information related to members of a household represented by a component graph, wherein the user-content activity information related to the members records content consumed by the members and activities of the members with respect to the content, and
estimating one or more interests of the household based on the user-content activity information;
a household content service provider implemented by a processor and configured for:
identifying a service household for personalized content service,
obtaining one or more interests estimated with respect to the service household, identifying content in alignment with the one or more interests associated with the service household, and
recommending the identified content to the service household.
